(19) United States
(12) Patent Application Publication
(10) Pub. No.: US 2002/0108657 A1
(43) Pub. Date: Aug. 15, 2002

(54) Container provided with means to keep inside of container under a constant pressure

(76) Inventor: Jen-Fu Chen, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/782,146

(22) Filed: Feb. 14, 2001

(51) Int. Cl. G05D 16/20

(52) U.S. Cl. 137/565.13

(57) ABSTRACT

A container is formed of a vessel, an air pump, a pressure triggering switch, and a battery set. The vessel is formed of a cylindrical main body and a lid for covering the open top of a receiving cell of the vessel. The air pump, the pressure triggering switch, and battery set are disposed in the lid for keeping the air pressure in the receiving cell at a desired level. When the air pressure in the receiving cell is so changed as to be higher than the desired level, the air pump is activated by the pressure triggering switch to draw the excess air out of the receiving cell until the air pressure in the receiving cell is equal to the desired level. The air pump is then automatically deactivated by the pressure triggering switch.

### FIELD OF THE INVENTION

The present invention relates generally to a container, and more particularly to a container provided with means to keep the inside of the container under a constant pressure.

### BACKGROUND OF THE INVENTION

There are certain conventional containers which are provided with a one-way air valve via which the containers are partially or completely exhausted of air by a manual air pump, so as to keep freshness of the article contained in the containers.

Such conventional containers as described above are defective in design in that the manual air pump is inefficient at best, and that the pressure of the inside of the containers can not be kept constantly at a predetermined level.

### SUMMARY OF THE INVENTION

The primary objective of the present invention is to provide a container which is free from the drawbacks of the conventional containers described above.

In keeping with the principle of the present invention, the foregoing objective of the present invention is attained by a container comprising a main body, an air pump, and a pressure triggering switch. The main body is exhausted of air by the air pump such that the pressure of the inside of the main body is kept at a desired level. When the pressure of the inside of the main body is so changed as to deviate from the desired level, the air pump is automatically activated by the pressure triggering switch to draw the air out of the inside of the main body unit the pressure of the inside of the main body reaches the desired level.

### BRIEF DESCRIPTION OF THE DRAWINGS

FIG. 1 shows a perspective view of a first preferred embodiment of the present invention.

FIG. 2 shows an exploded view of the first preferred embodiment of the present invention.

FIG. 3 shows a sectional view taken along the direction indicated by a line 2-2 as shown in FIG. 1.

FIG. 4 shows a logic diagram of a control program of the first preferred embodiment of the present invention.

FIGS. 5 and 6 are schematic views of the first preferred embodiment of the present invention at work.

FIG. 7 shows an exploded view of a second preferred embodiment of the present invention.

### DETAILED DESCRIPTION OF THE INVENTION

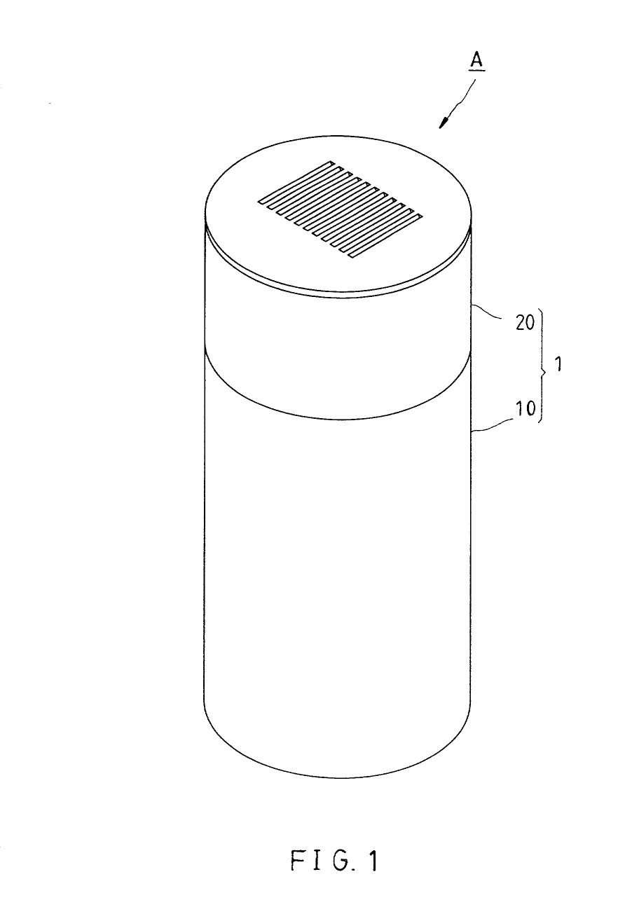

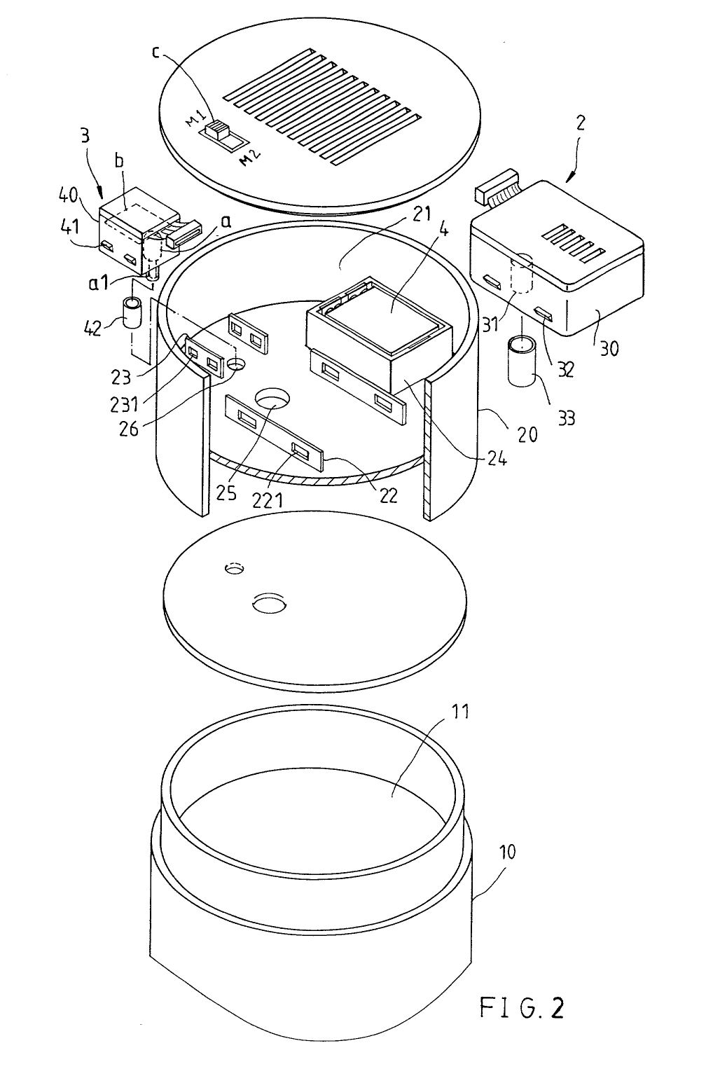

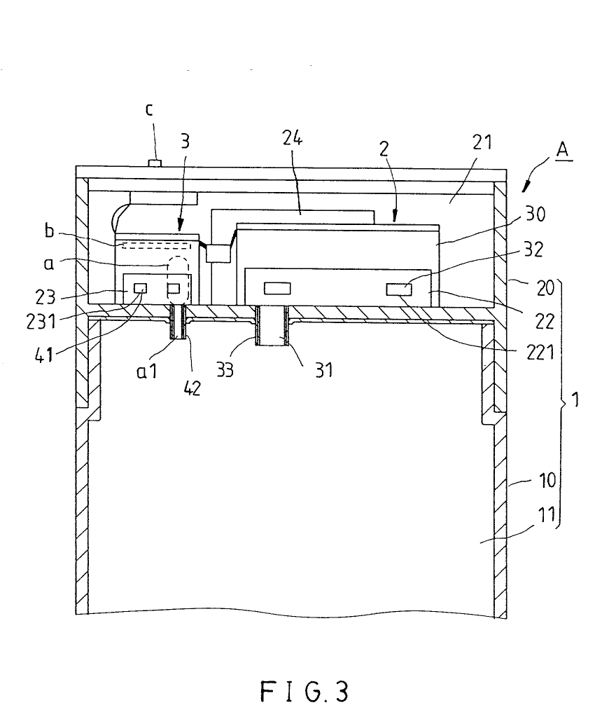

As shown in FIGS. 1-3, a container “A” of the first preferred embodiment of the present invention comprises a vessel 1, an air pump 2, a pressure triggering switch 3′ and a battery set 4.

The vessel 1 is formed of a main body 10 and a lid 20. The main body 10 is of a cylindrical construction and is provided with a receiving cell 11 with an open top, which is sealed off by the lid 20. The lid 20 is provided in the interior thereof with a receiving space 21 which is in turn provided with two first walls 22 parallel to each other, and two second walls 23 parallel to each other. The first walls 22 are provided with two first retaining holes 221, whereas the two second walls 23 are provided with two second retaining holes 231. The receiving space 21 of the lid 20 is provided with a battery mount 24 and is further provided in the bottom thereof with a first through hole 25 and a second through hole 26.

The air pump 2 comprises a housing 30 and an air pump nose 31 extending out of the bottom of the housing 30. The housing 30 is provided in two side walls with two retaining projections 32 corresponding in location to the two first retaining holes 221 of the first walls 22. The air pump 2 is located in the receiving space 21 of the lid 20 such that the air pump nose 31 is put through the first through hole 25 in conjunction with a gasket 33, and that the retaining projections 32 of the housing 30 are retained in the first retaining holes 221 of the first walls 22.

The pressure triggering switch 3 comprises a housing 40, a differential pressure sensor “a” disposed in the housing 40, and a control chip “b”. The sensor has a sensor tip “al” which is jutted out of the housing 40. The housing 40 is provided in two side walls with two retaining projections 41 corresponding in location to the two second retaining holes 231 of the second walls 23. The pressure triggering switch 3 is disposed in the receiving space 21 of the lid 20 such that the sensor tip “al” is put through the second through hole 26 of the lid 20 in conjunction with a gasket 42, and that the two retaining projections 41 are retained in the two second retaining holes 231 of the second walls 23.

The battery set 4 is disposed in the battery mount 24 and is used to provide the pressure triggering switch 3 and the air pump 3 with power.

The differential pressure sensor “a” of the pressure triggering switch 3 transmits an output voltage in accordance with the pressure difference between the sensed pressure and the reference pressure which is the atmospheric pressure. The pressure difference and the output voltage have the following linear relationships:

Sensed pressure=reference pressure (atmospheric pressure), output voltage being 3V;

Sensed pressure=1.15 atm, output voltage being 3.3V;

Sensed pressure=0.1 atm, output voltage being 1.2V;

Sensed pressure=0.25 atm, output voltage being 1.5V.

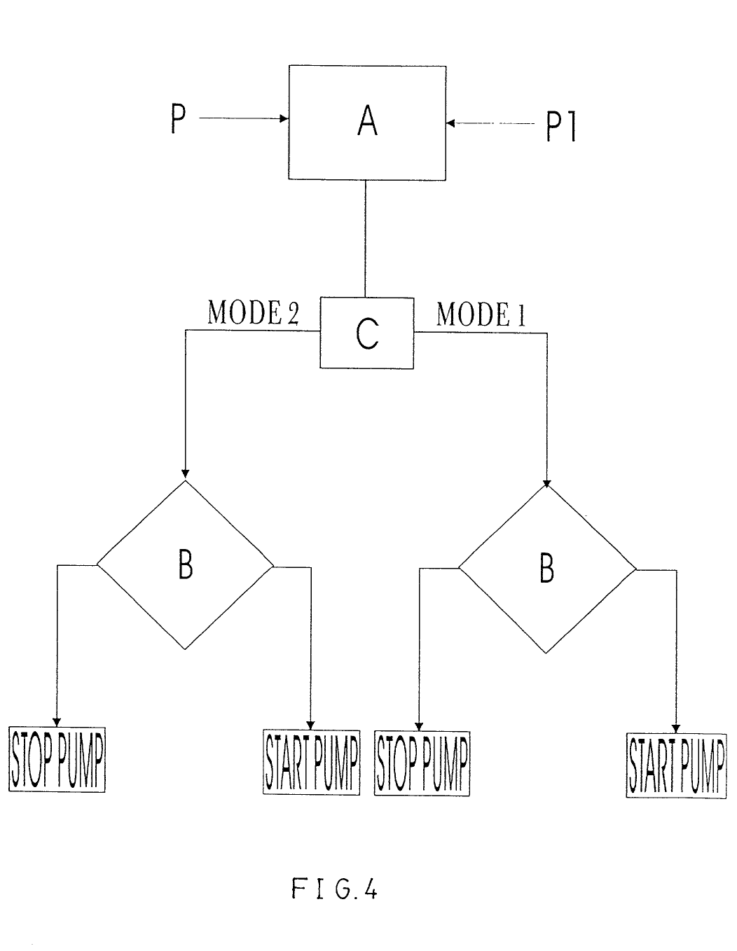

The control chip “b” is provided with a control program having two logic control modes, which are switched by a manual switch “c”, as shown in FIG. 4. The logic reference source is the output voltage of the pressure sensor “a”. When the program is in the state of the first control mode, the output voltage of the pressure sensor “a” is greater than or equal to 3.3V. As a result, the air pump 2 is turned on by the program. When the output voltage is smaller than or equal to 1.2V, the air pump 2 is turned off by the program. When the program is in the state of the second control mode, the output voltage of the pressure sensor “a” is greater than or equal to 1.5V. As a result, the air pump 2 is turned on by the program. If the output voltage is smaller than or equal to 1.2V, the air pump 2 is turned off by the program.

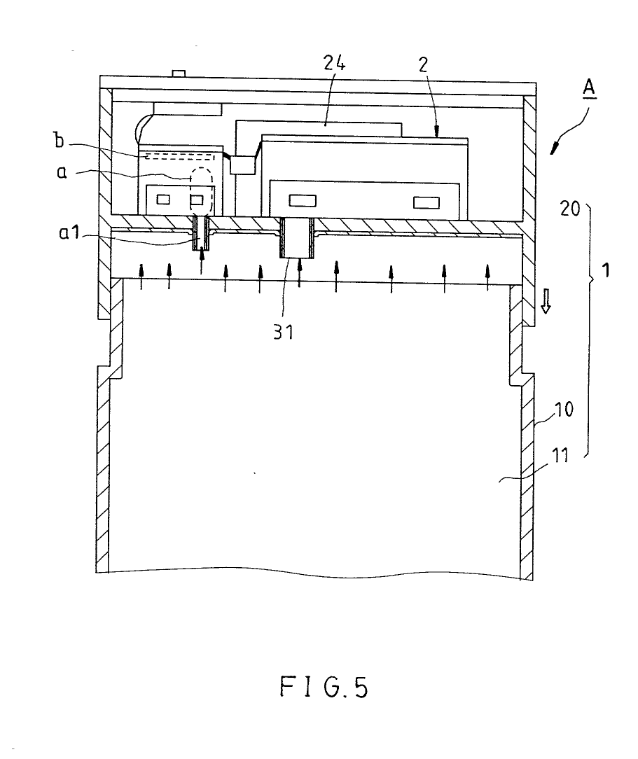

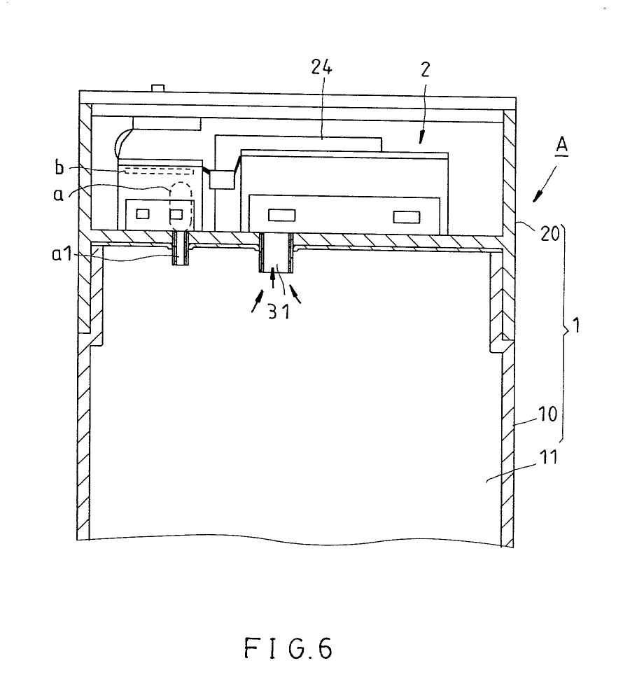

In operation, the control mode of the control chip “b” is manually switched to the first mode before the lid 20 is joined with the main body 10. As the lid 20 is joined with the main body 10, the air in the receiving cell 11 is so compressed that the air pressure exceeds 1.15 atm, which is sensed by the pressure sensor “a” of the pressure triggering switch 3 to transmit an output voltage greater than 3.3V, thereby causing the control program of the control chip “b” to turn on the air pump 2 to draw the air out of the vessel 1, as shown in FIG. 5. As soon as the air pressure in the vessel 1 is smaller than 1.2V, the air pump 2 is turned off by the program. Thereafter, the control mode of the control chip “b” is switched to the second mode. In the event that the air pressure in the vessel 1 increases to a level greater than 0.25 atm, which is then sensed by the pressure sensor “a” of the pressure triggering switch 3 to result in an output voltage greater than 1.5V. As a result, the air pump 2 is once again turned on by the control program to draw the excess air out of the vessel 1, so as to keep the pressure in the vessel 1 at a constant level which is under 0.1 atm.

The lid 20 may be provided with a display, such as a liquid crystal display, which cooperates with the pressure sensor “a” to exhibit the pressure value in the vessel 1 of the container of the present invention.

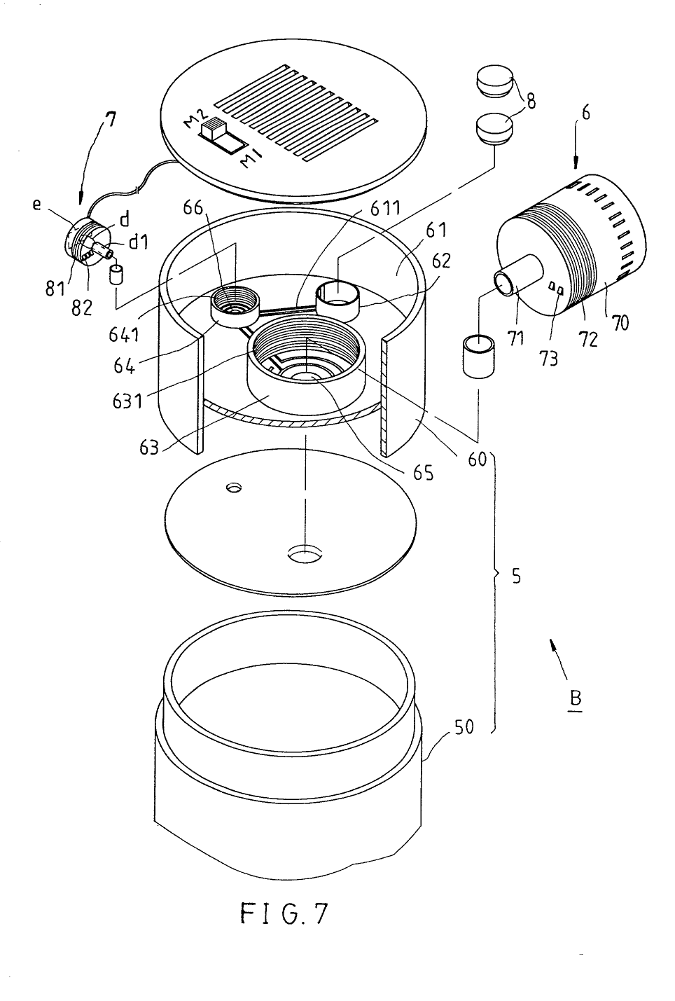

As shown in FIG. 7, a container “B” of the second preferred embodiment of the present invention comprises a vessel 5, an air pump 6, a pressure triggering switch 7, and a battery set 8.

The vessel 5 is formed of a cylindrical main body 50, and a lid 60 which is provided with a receiving space 61. The receiving space 61 is provided with a circular battery mount 62 for mounting a mercury battery set 8, a first circular wall 63 provided in the inner wall with inner threads 631, and a second circular wall 64 provided in the inner wall with inner threads 641. The receiving space 61 is further provided in the bottom wall with a first through hole 65 and a second through hole 66.

The air pump 6 is formed of a housing 70, and an air pump nose 71 extending out of the bottom of the housing 70. The housing 70 is provided in the outer periphery of the lower segment thereof with outer threads 72 corresponding in location to the inner threads 631 of the first circular wall 63. The air pump 6 is fastened with the lid 60 such that the outer threads 72 of the air pump 6 are engaged with the inner threads 631 of the first circular wall 63, and that the air pump nose 71 is put through the first through hole 65.

The pressure triggering switch 7 is formed of a housing 80, a differential pressure sensor “d”, and a control chip “e”. The control chip “e” is provided with a control program identical to the one described above. The sensor “d” has a sensing tip “dl” extending out of the housing 80. The housing 80 is provided with outer threads 81 corresponding in location to the inner threads 641 of the second circular wall 64. The pressure triggering switch 7 is fastened with the lid 60 such that the outer threads 81 of the housing 80 are meshed with the inner threads 641 of the second circular wall 64 of the lid 60, and that the sensing tip “dl” is received in the second through hole 66.

The receiving space 61 is provided in the bottom wall with an electrical connection path 611 for connecting the battery mount 62, the pressure triggering switch 7, and the connection terminals 82, 73 of the air pump 6.

What is claimed is:

1. A container comprising:
a vessel formed of a main body and a lid, said main body provided in an interior with a receiving cell having an open top which is sealed off by said lid;
an air pump disposed on said vessel to draw air out of said vessel so as to keep air pressure in said receiving cell of said vessel at a predetermined level; and
a pressure triggering switch disposed on said vessel and provided with a sensor for sensing the air pressure in said receiving cell so as to control said air pump in such a manner that said air pump is turned off at the time when the air pressure in said receiving cell is equal to the predetermined level, and that said air pump is turned on at the time when the air pressure in said receiving cell is greater than the predetermined level.

2. The container as defined in claim 1, wherein said pressure triggering switch is formed of a differential pressure sensor and a control chip, said sensor having a sensing tip which is extended into said receiving cell for sensing the air pressure in said receiving cell in such a manner that said sensor transmits an output voltage in accordance with a pressure difference between a sensed pressure and a reference pressure which is atmospheric pressure, said control chip provided with a control program to turn on or off said air pump in response to said output voltage.

3. The container as defined in claim 2, wherein said control program has two logic control modes which are manually switched.

4. The container as defined in claim 1, wherein said vessel is provided with a battery mount for mounting a battery set serving as a power source of said air pump and said pressure triggering switch.

5. The container as defined in claim 1, wherein said pressure triggering switch and said air pump are mounted in said lid of said vessel.

6. The container as defined in claim 4, wherein said battery mount is located in said lid.

7. The container as defined in claim 1, wherein said lid is provided with a receiving space, two parallel first walls, and two parallel second walls, with each of said first walls and said second walls having two retaining holes, said receiving space provided in a bottom wall with a first through hole and a second through hole; wherein said air pump is formed of a housing and an air pump nose extending out of a bottom wall of said housing, said housing provided in two opposite walls with two retaining projections, said air pump being disposed in said receiving space of said lid such that said air pump nose is put through said first through hole of said bottom wall of said receiving space, and that said retaining projections of said housing of said air pump are retained in said retaining holes of said first walls of said lid; wherein said pressure triggering switch is formed of a housing and a pressure sensing tip extending through said housing, said housing provided in two opposite walls with two retaining projections corresponding in location to said retaining holes of said second walls of said lid, said switch being disposed in said lid such that said pressure sensing tip is put through said second through hole of said lid, and that said retaining projections of said housing of said switch are retained in said retaining holes of said second walls of said lid.

8. The container as defined in claim 6, wherein said lid is provided with a receiving space; wherein said battery mount is disposed in said receiving space.

9. The container as defined in claim 1, wherein said vessel is provided with a liquid crystal display which is connected with said differential pressure sensor for exhibiting an air pressure value of said vessel.

10. The container as defined in claim 1, wherein said lid is provided with a receiving space, said receiving space provided with a circular battery mount for mounting a mercury battery set, a first circular wall having inner threads, and a second circular wall having inner threads, said receiving space further provided in a bottom wall with a first through and a second through hole; wherein said air pump is formed of a housing and an air pump nose extending through said bottom wall of said housing, said housing provided with outer threads, said air pump being fastened with said lid such that said outer threads of said housing of said air pump are meshed with said inner threads of said first circular wall, and that said air pump nose is put through said first through hole; wherein said pressure triggering switch is formed of a housing and a pressure sensing tip extending out of said housing, said housing provided with outer threads, said switch being fastened with said lid such that said outer threads of said housing of said switch are meshed with said inner threads of said second circular wall, and that said pressure sensing tip is put through said second through hole; wherein said receiving space of said lid is provided in a bottom with an electrical connection path for connecting said battery mount, said pressure triggering switch, and said air pump.
